(19) United States
(12) Patent Application Publication
(10) Pub. No.: US 2025/0117614 A1
(43) Pub. Date: Apr. 10, 2025

(54) RFID CASINO CHIPS HAVING MULTIPLE RFID STANDARDS AND METHODS OF THEIR MANUFACTURE

(71) Applicant: Walker Digital Table Systems, LLC, Las Vegas, NV (US)

(72) Inventors: Heinz Zollinger, Hope Island (AU); Mark Hettinger, Las Vegas, NV (US)

(21) Appl. No.: 18/983,516

(22) Filed: Dec. 17, 2024

Related U.S. Application Data
(63) Continuation of application No. PCT/US23/25686, filed on Jun. 19, 2023.
(60) Provisional application No. 63/353,608, filed on Jun. 19, 2022.

(51) Int. Cl. G06K 19/04; A63F 3/00; G06K 7/10; G06Q 50/34; G07F 17/32

(52) U.S. Cl. CPC G06K 19/047; G06K 7/10297; G07F 17/322; G07F 17/3248; A63F 3/00157; G06Q 50/34

(57) ABSTRACT

A dual standard RFID chip for use with one or more electronic table systems comprises a carrier body and first and second RFID chips mounted with respect to the carrier body. The first and second RFID chips are encoded with a first RFID standard and a second RFID standard different from the first RFID standard. A first inlay may be mounted to the carrier body where the first inlay comprises the first RFID chip encoded with the first RFID standard. A second inlay is mounted to the carrier body where the second inlay comprises the second RFID chip encoded with the second RFID standard. The first RFID standard is a Mode 2 RFID standard and the second RFID standard is a Mode 3 RFID standard.

### CROSS-REFERENCE TO RELATED APPLICATIONS

This application is a Continuation Application of PCT Application No. PCT/US23/25686 filed Jun. 19, 2023 and titled RFID CASINO CHIPS HAVING MULTIPLE RFID STANDARDS AND METHODS OF THEIR MANUFACTURE, which PCT Application claims benefit and priority under 35 U.S.C. § 119 (e) to, and is a Non-Provisional of, U.S. Provisional Patent Application No. 63/353,608 filed on Jun. 19, 2022 and titled “RFID CASINO CHIPS HAVING MULTIPLE RFID STANDARDS AND METHODS OF THEIR MANUFACTURE”. The entirety of each of these Applications is hereby incorporated by reference herein in its entirety, for all purposes.

### BACKGROUND

Radio frequency identification (RFID) is a technology having many applications including, for example, tracking and management of casino chips equipped with RFID technology in a casino environment.

RFID standards and protocols are the basis of RFID chip design. Currently, the common international RFID standards and protocols are ISO/IEC 18000, ISO11784, ISO11785, ISO/IEC 14443, ISO/IEC 15693, EPC Gen2, etc. An RFID chip is typically manufactured with a single and particular RFID standard. In the past several years, enormous efforts have been dedicated toward the goal of developing improved RFID standards that allow for exchange and processing of data at increasingly high speeds.

While substantial strides have been made in developing improved RFID standards, many industries and users have existing legacy systems and products that utilize products that rely on RFID chips utilizing an existing RFID standard. It may not be economically feasible to implement new systems or products that utilize RFID chips comprising newer RFID standards if this means that the existing systems and products which utilize RFID chips comprising the older RFID standards would need to be replaced. Similarly, it may not be economically feasible to continue to use existing systems and products that utilize older RFID standards if products utilizing newer RFID standards offer desirable benefits, since managing or supporting different products that utilize different RFID standards may be cost prohibitive and/or otherwise undesirable (e.g., it may cause confusion to customers, staff, workflows, etc.).

### SUMMARY

Accordingly, an RFID-enabled product that includes a plurality (e.g., two (2)) distinct inlays within it is provided. For example, the RFID-enabled product may comprise: a first inlay comprising an RFID chip utilizing a first RFID protocol (e.g., an older RFID protocol) and a second inlay comprising an RFID chip utilizing a second RFID protocol (e.g., a newer RFID protocol) is provided. Such an RFID-enabled product allows a given user/environment to include or utilize some equipment that is operable to utilize/read the first RFID protocol as well as some equipment that is operable to utilize/read the second RFID protocol, without the need for two different sets of RFID-enabled products (e.g., one set equipped with the first RFID protocol for use with the equipment that is operable to read the first RFID protocol and a second set equipped with the second RFID protocol for use with the equipment that is operable to read the second RFID protocol). It should be understood that although the embodiments described herein refer to two (2) RFID protocols, any number of distinct RFID protocols greater than one are within the scope of the invention(s) described herein.

In some embodiments, a dual standard RFID chip for use with one or more electronic table systems comprises a carrier body and first and second RFID chips mounted with respect to the carrier body. The one or more RFID chips are encoded with a first RFID standard and a second RFID standard different from the first RFID standard.

In some embodiments, the first RFID standard is a Mode 2 RFID standard and the second RFID standard is a Mode 3 RFID standard.

In accordance with some embodiments, a first inlay is mounted to the carrier body where the first inlay comprises the first RFID chip encoded with the first RFID standard. A second inlay is mounted to the carrier body where the second inlay comprises the second RFID chip encoded with the second RFID standard. The first RFID standard may be a Mode 2 RFID standard and the second RFID standard may be a Mode 3 RFID standard.

In some embodiments, a carrier spacer is disposed between the first and second inlays within the carrier body.

In accordance with some embodiments, a method comprises registering first and second RFID identifiers of first and second RFID chips to a common record ID of a single dual standard RFID chip; wherein the method is performed by at least one processor coupled to memory.

In some embodiments, the first RFID chip is encoded with a first RFID standard and the second RFID chip is encoded with a second RFID standard different from the first RFID standard.

In some embodiments, the method includes reading with a first RFID standard reader the first RFID chip to confirm the first RFID identifier is registered to the common record ID of the single dual standard RFID chip. In some embodiments, the first RFID chip is encoded with a Mode 2 RFID standard and wherein the first RFID standard reader is a Mode 2 standard reader.

In some embodiments, the method includes reading with a second RFID standard reader the second RFID chip to confirm the second RFID identifier is registered to the common record ID of the single dual standard RFID chip. In some embodiments, the second RFID chip is encoded with a Mode 3 RFID standard and wherein the second RFID standard reader is a Mode 3 standard reader.

In accordance with some embodiments, a method comprises assigning a common record ID to a single dual standard RFID chip, registering first and second RFID chip identifiers of respective first and second RFID chips to the common record ID, associating the common record ID to a player identity of a player, utilizing by the player, the single dual standard RFID chip in a wagering activity at an electronic gaming table, reading with an RFID standard reader, associated with the electronic gaming table, one of the first and second RFID chips, associating the RFID chip identifier of the read one of the first and second RFID chips to the common record ID and updating a casino database to reflect the wagering activity of the player associated with the common record ID.

In some embodiments, registering first and second RFID chip identifiers includes registering the first RFID chip identifier having a first RFID standard and registering a second RFID chip identifier having a second RFID standard different from the first RFID standard. In some embodiments, the first RFID standard is a Mode 2 RFID standard and wherein the second RFID standard is a Mode 3 RFID standard. In some embodiments, reading with an RFID standard reader includes reading one of the first and second RFID chips with one of a Mode 2 RFID standard and a Mode 3 RFID standard reader.

In some embodiments, reading with an RFID standard reader includes reading the first RFID chip to obtain the first RFID chip identifier. In some embodiments, reading with an RFID standard reader includes reading the second RFID chip to obtain the second RFID chip identifier.

### BRIEF DESCRIPTION OF THE DRAWINGS

The figures depict embodiments for purposes of illustration only. One skilled in the art will readily recognize from the following description that alternative embodiments of the systems and methods illustrated herein may be employed without departing from the principles described herein, wherein:

FIG. 1 is a perspective view of a dual standard RFID chip, in accordance with some embodiments described herein;

FIG. 2 is a top plan view of the dual standard RFID chip, in accordance with some embodiments described herein;

FIG. 3 is an exploded perspective view of a dual standard RFID chip, in accordance with some embodiments described herein;

FIG. 4 is an exploded elevation view of a dual standard RFID chip, in accordance with some embodiments described herein;

FIG. 5 is a side cross-sectional view of a dual standard RFID chip, in accordance with some embodiments described herein;

FIG. 6 is a schematic view of a dual standard RFID chip, in accordance with some embodiments described herein;

FIG. 7 is a flow chart illustrating an exemplary methodology for testing a dual standard RFID chip, in accordance with some embodiments described herein;

FIG. 8 is a flow chart illustrating an exemplary methodology for tracking waging activity of a dual standard RFID chip, in accordance with some embodiments described herein;

FIG. 9 is a block diagram of a system for implementing a dual standard RFID chip, in accordance with some embodiments described herein; and

FIG. 10 is a block diagram of a system for implementing a dual standard RFID chip, in accordance with some embodiments described herein.

### DETAILED DESCRIPTION

### I. TERMS & DEFINITIONS

Terminology and Definitions—the following terms will be used throughout the current description in accordance with the definitions below. The embodiments described herein are described with reference to a specific use case within a casino (such as for table games that utilized RFID-enabled products such as Casino Chips); accordingly, some of the definitions reference specific casino-related embodiments. It should be understood that a dual standard RFID chip as is described herein could be utilized in different settings and use cases and the casino embodiments referenced herein are for illustrative and non-limiting purposes.

Casino Chip—a small disc used instead of currency in a casino. Prior to Applicant's invention(s), an RFID-enabled Casino Chip includes a single Inlay embedded within it, one which utilizes a single and particular RFID standard (e.g., Mode 2 PJM). The improved Casino Chip embodied in Applicant's invention(s) would include multiple (e.g., two) Inlays, each Inlay utilizing a different RFID standard, such that the improved Casino Chip can be read by a first Reader operable to read the first RFID standard and a second Reader operable to read the second RFID standard (and a Reader of additional RFID standards, if more than two Inlays (and thus RFID standards) were included in the Casino Chip).

Inlay—the RFID chip, Tag Antenna and Substrate together, typically on a film face.

Phase Jitter Modulation (PJM)—PJM is a modulation method specifically designed to meet the unique requirements of passive RFID tags technology. The Mode 2 PJM standard that is referenced herein complies with the International Standard ISO/IEC 18000 Part 3 Mode 2 and operates at 13.56 MHz. The Mode 2 PJM standard data rate is 423,75 kbit/s.

Mode 3 standard—a newer RFID standard that also operates at 13.56 MHz and is capable of higher data rates for some applications. The air interface uses amplitude shift keying (ASK) modulation in a similar way to ISO/IEC 14443 and gives a higher speed air interface (higher than ISO/IEC 15693) and the ability to recognize large quantities of tags in the field. The actual performance are 100 kbit/s to the tag and 424 or 848 kbit/s from the tag at maximum speed. There are slower rates also available. There is also an optional PJM mode available that provides speeds of 212 kbit/s to the tag and 106/channel from the tag.

Reader (also referred to as an Interrogator or RFID Reader)—hardware (such as may be located on an RFID-enabled table game, cage, or other location), placed where items equipped with RFID chips can be read. A Reader may consist of a scanner and one or more antennas (referred to as Reader Antennas), and be operable to transmit and/or receive signals, provide power to passive RFID Tags, and/or communicate with the RFID Tag and receive information from the RFID Tag.

RFID chip—(also referred to as Silicon Chip or Integrated Chip “IC” herein)—is responsible for data storage (e.g., storing Casino Chip ID) as well as processing logic based on the respective protocol. An RFID chip is manufactured in accordance with a specific RFID standard. An RFID chip may be designed to a specific RFID standard, such as a Mode 2 (PJM) RFID standard (referred to as a Mode 2 RFID chip herein) or a Mode 3 standard (referred to as a Mode 3 RFID chip herein). In the embodiments described herein, which have specific application in the casino environment, a Casino Chip that includes both a Mode 2 RFID chip and a Mode 3 RFID chip is referred to as a Dual standard RFID Casino Chip.

RFID Tag (also referred to as simply a “Tag”)—is comprised of an RFID chip coupled with a Tag Antenna.

Substrate—the substance that holds the Tag Antenna and RFID chip together, typically Silicon in the applications described herein. A silicon substrate is an example of a substrate and use of the term substrate is intended to encompass a silicon substrate herein.

Tag Antenna—the antenna or antenna coil in the RFID Tag and that is part of a given Inlay that is responsible for receiving and transmitting the signal from the Reader/Interrogator. A Tag Antenna typically has dual functions—a) generate voltage to power the RFID chip, b) send & receive data from the RFID reader.

### II. General Description

Various items that are tracked and identified via RFID technology, such as RFID-enabled Casino Chips, currently use a particular RFID standard (e.g., Mode 2 PJM). This means that the items include an Inlay and/or RFID Tag that utilizes the particular RFID standard and that the Antenna Readers of the RFID-enabled systems that track such items (e.g., RFID-enabled casino gaming tables that utilize RFID-enabled Casino Chips and thus have Reader Antennas at one or more of player positions, dealer position, shared bet positions, chip trays, cages at which player can purchase Casino Chips or trade them in for currency, and carts used to transport Casino Chips throughout a casino) are configured to read data encoded on a chip that uses a given RFID standard. For example, a casino using Casino Chips embedded with an Inlay that utilizes the particular Mode 2 PJM standard also utilizes systems that include Reader Antennas configured to read Casino Chips encoded using the Mode 2 PJM standard. For some casino applications, a newer RFID standard, the Mode 3 standard, has been developed and offers advantages. There is ongoing development work related to the Mode 3 standard and it is anticipated that some product applications (such as in the casino industry) may turn more and more to using items that utilize the Mode 3 standard.

Applicant has recognized that in some circumstances it may be advantageous to develop methods and systems that allow businesses that currently utilize items encoded with a first RFID standard (e.g., the Mode 2 PJM standard that is popular with casinos and utilized on Casino Chips) to update at least some of their RFID-enabled products and systems to ones that utilize items encoded with a second RFID standard (e.g., the Mode 3 standard) without incurring undue costs and complications from an environment that includes tracking some items encoded with (and thus trackable) using only the first RFID standard and tracking other items encoded with (and thus trackable) using only the second RFID standard. For example, it may be beneficial for a casino to use Casino Chips encoded with the Mode 2 PJM standard for some RFID enabled table games while also using Casino Chips encoded with the Mode 3 standard for other RFID enabled table games. Having two different types of RFID-enabled Casino Chips being utilized within a given casino or gaming location/environment may cause confusion for patrons, staff and systems that would need to differentiate between the two and be operable to recognize whether a given Casino Chip is a Mode 2 PJM Casino Chip or a Mode 3 Casino Chip. Any type of confusion or extra processing power that such a situation may require may cause accounting errors or unacceptable delays, with the understanding that in a casino any delay may cause customer frustration and/or game pace (and thus revenue) decline.

For example, in a casino application, some casino equipment manufacturers that sell RFID enabled table games (for games such as baccarat, roulette or poker), the RFID enabled table games are equipped with Readers that are currently operable to read Casino Chips comprising Mode 2 RFID chips. Applicant's PCT Patent Application No. PCT/US2016/032797, filed May 16, 2106 in the name of Moore et al. (Publication No. WO2016187164, published Nov. 24, 2016); titled SYSTEMS AND METHODS FOR UTILIZING RFID TECHNOLOGY TO FACILITATE A GAMING SYSTEM (“Applicant's '164 PCT Publication”) describes one example of such an RFID enabled table game and is incorporated by reference herein for all purposes.

Applicant has recognized that for some particular applications within a given casino, the casino operator may benefit from introducing products with Readers equipped to read Casino Chips comprising Mode 3 RFID chips. Applicant has recognized that gaming equipment manufacturers whose products utilize the Mode 2 PJM standard would remain more competitive and/or an attractive option to casinos if they could provide a cost-effective manner of allowing the casinos to continue to use Casino Chips utilizing the Mode 2 PJM standard and Readers operable to read the Mode 2 PJM standard, while also installing/utilizing products and equipment that utilize newer Mode 3-enabled Casino Chips for some applications, without needing to incur the substantial costs of purchasing two different sets of Casino Chips and incurring the undesirable consequences of having the two different types of Casino Chips (one set being encoded with the Mode 2 PJM standard and the other set being encoded with the Mode 3 standard) utilized within the casino environment. Purchasing a set of Casino Chips is a significant expense for a casino and it is not practical to expect a casino to purchase both a Mode 2 PJM Casino Chip Set and a Mode 3 Casino Chip Set. Aside from a cost perspective, it would add confusion and slow down game play to have some Casino Chips that are encoded with the Mode 2PJM standard and some Casino Chips that are encoded with the Mode 3 standard within the same casino (e.g., a player may place a Mode 2 Casino Chip on a table that is only equipped to read Mode 3, and need to be told that this is the wrong chip, cannot be wagered on this table, which may cause the player to leave and not return to play the game).

### III. Detailed Description of some Embodiments

In accordance with some embodiments, a Casino Chip is designed and manufactured to include a plurality of (e.g., two) RFID protocols. For example, a Casino Chip is designed and manufactured such that it is encoded with both a Mode 2 PJM standard and a Mode 3 standard, such that it could be read by either a Mode 2 PJM Reader or a Mode 3 Reader.

In accordance with some embodiments, a Casino Chip may be encoded with both a Mode 2 PJM standard and a Mode 3 standard (“dual-standard RFID casino chip”), which may be accomplished by including both a Mode 2 PJM Inlay (also referred to as a “Mode 2” Inlay) and a Mode 3 Inlay (also referred to as a “Mode 3” Inlay) in the Casino Chip. For example, one Inlay could be layered on top of the other Inlay (perhaps with a carrier (e.g., ½ mil mylar) layer in between).

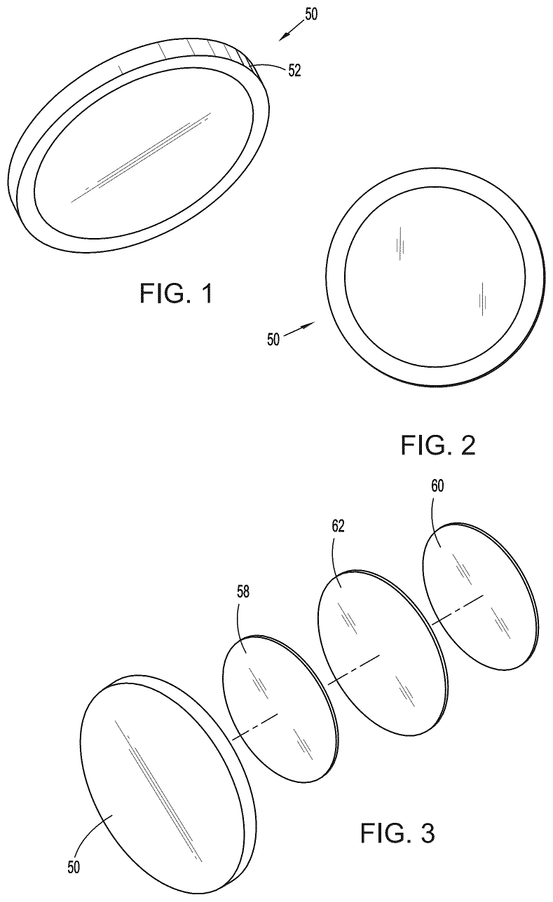

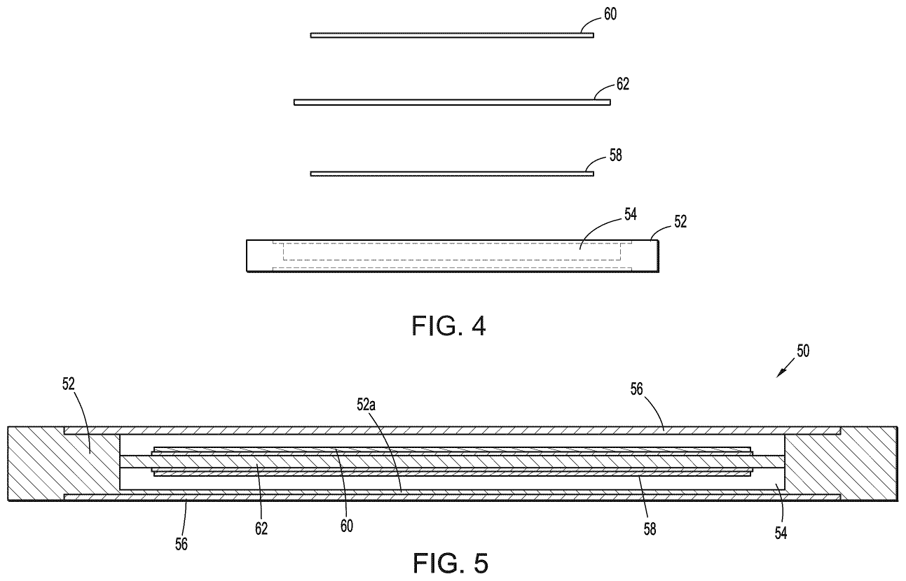

FIGS. 1-5 illustrates one example design of a dual standard RFID chip 50 in accordance with some embodiments. The dual standard RFID chip 50 includes an outer carrier body 52 defining a body interior 54 and opposed sides 56 secured to the outer body 52. The outer carrier body 52 may have a lower body wall 52a to which one of the opposed sides 56 is coupled. In some embodiments, the opposed side 56 opposite the lower body wall 52a encloses the body interior 54. In FIGS. 3 and 4, the opposed sides 56 are not shown for clarity purposes. The carrier body 52 may be fabricated of any suitable RF-lucent material including a suitable RF-lucent polymeric material. The thickness and diameter of the outer carrier body is about 3.33 millimeters (mm) and 40 millimeters (mm) respectively; however, other dimensions are contemplated. The opposed sides 56 may include one or more decals or indicia representative of, for example, the casino's name and logo, value, game-type etc. as well as information about the dual standard RFID chip 50, such as its denomination, unique identifier(s) and/or chip set identifier. Disposed within the interior 54 of the body carrier 52 are first and second inlays 58, 60 separated by a carrier spacer 62. The first inlay 58 is a Mode 2 inlay and includes a substrate and an encoded Mode 2 standard RFID chip with an antenna. The second inlay 60 is a Mode 3 inlay and includes a substrate and an encoded Mode 3 standard RFID chip with an antenna. The first and second inlays 58, 60 may define a thickness ranging from about 0.24 millimeters (mm) to about 0.32 millimeters (mm) or about 0.28 millimeters (mm); however, other dimensions are contemplated. The carrier spacer 62 may be in contacting relation with the first and second inlays 58, 60. The carrier spacer 62 may be fabricated from a suitable RF-lucent polymeric material. The carrier spacer 62 may define a thickness ranging from about 0.45 millimeters (mm) to about 0.55 millimeters (mm) or about 0.50 millimeters (mm). Other dimensions are contemplated.

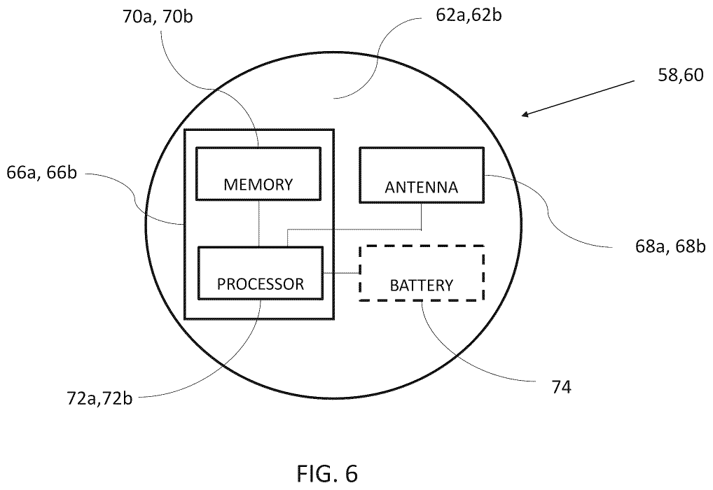

FIG. 6 schematically illustrates an exemplary embodiment of components of the inlays 58, 60 of the dual standard RFID chip 50 in accordance with some embodiments. In FIG. 6, only one inlay 58, 60 is shown for ease of illustration. Each inlay 58, 60 respectively includes a substrate 62a, 62b and an RFID tag mounted with respect to the substrate 62a, 62b. The RFID tag may be passive or active. The RFID tag comprises an RFID chip 66a, 66b and an antenna 68a, 68b coupled to the RFID chip 66a, 66b. Each RFID chip 66a, 66b includes a memory 70a, 70b and an electronic circuit or processor 72a, 72b. In an active RFID tag, the inlays 58, 60 may include a battery 74. As noted above, in some embodiments, the first inlay 58 is a Mode 2 inlay in which the RFID chip 66a is a Mode 2 standard RFID chip and the second inlay 60 is a Mode 3 inlay in which the RFID chip 66b is a Mode 3 standard RFID chip. In use of either inlay 58, 60, the electronic processor 72a, 72b and antenna 68a, 68b act as a transponder capable of responding to an interrogator (not shown). In essence, the interrogator sends out an electromagnetic signal that impinges upon the antenna 68a, 68b, exciting a current within the electronic processor 72a, 72b. In response to the excited current, the electronic processor 72a, 72b causes the antenna 68 to emit a second electromagnetic signal as a response, which is received by the interrogator. The second signal has identifying information about the RFID assembly 50 encoded therein such that the interrogator can identify the dual standard RFID chip 50 on receipt of the second signal. The second signal may be generated passively or actively. In embodiments involving a passive RFID chip 66a, 66b described herein, the energy from the interrogation signal provides sufficient power for the electronic processor 72a, 72b to use to send the second signal. In embodiments utilizing an active RFID chip 66a, 66b, the electronic processor 72a, 72b may include a battery or other power source, which is used to power the generation of the second signal.

In some embodiments, the RFID chips 66a, 66b may be mounted on a single substrate including multiple chips 66a, 66b. In some embodiments, the RFID chips 66a, 66b may be mounted in side by side relation on a single substrate.

Use of the dual standard RFID casino chip assemblies described herein would allow a casino the flexibility to have some tables on the floor equipped with Mode 2 Readers and some equipped with Mode 3 Readers, such that certain game applications for which the Mode 3 standard offers advantages could utilize the Mode 3 standard of the same Casino Chip that could also be used on another gaming table that utilizes the Mode 2 PJM standard. The dual standard RFID chips described herein would also allow for a given table to use both Mode 2 PJM and Mode 3 Readers. For example, in one illustrative application, the player positions and dealer position of an RFID enabled table game may be equipped with a Mode 3 Reader while a chip tray may be equipped with a Mode 2 PJM Reader.

In accordance with some embodiments, a dual standard RFID Chip would require modifications to existing Casino Chip manufacturing and tracking processes, to account for the fact that there are two distinct RFID standards included on a given Casino Chip.

For example, each RFID chip 66a, 66b of the inlays 58, 60 has a distinct/unique Casino Chip Identifier (“ID”) encoded thereon. Thus, a dual standard RFID chip 50 would, in at least one embodiment, be associated/encoded with 2 different RFID chip IDs that both refer to the same physical Casino Chip. It is also contemplated that the dual standard RFID chip 50 may include more than 2 inlays and RFID chips.

In another example, adjustments to the manufacturing process may include having 2 (or however many, depending on the number of RFID standards being included within the Casino Chip) programming stations (one for each standard), to program the RFID chip 66a, 66b in each Inlay 58, 60 in accordance with the appropriate RFID standard. Further, once each of the inlays 58, 60 is added and programmed, the manufacturing process should include a distinct confirmation/reading step for each standard, to ensure that each standard on the same chip refers to the same value.

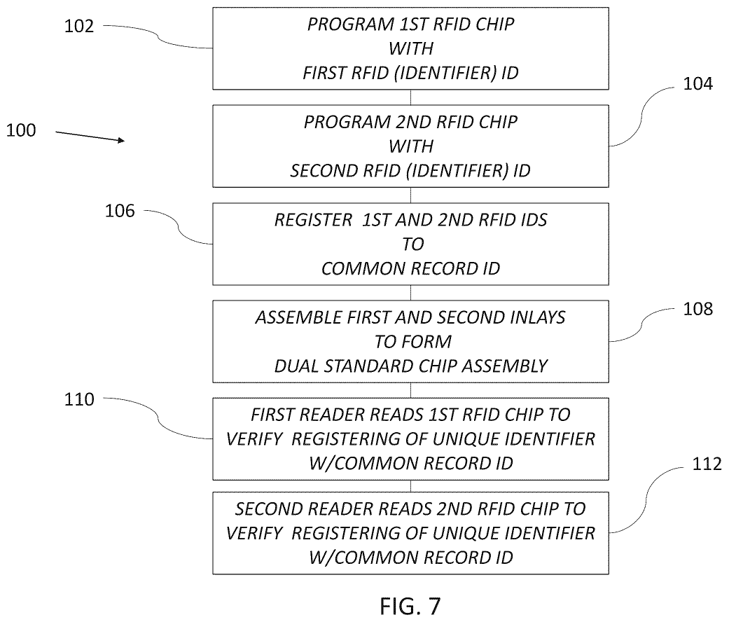

For example, FIG. 7 illustrates one exemplary methodology for manufacturing one or more of the dual standard RFID chips 50 according to some embodiments. The process 100 includes programming the RFID chip 66a of an encoded first inlay 58 (e.g., a Mode 2 inlay) with a first unique identifier at a first programming stations (STEP 102) and programming the RFID chip 66b of the encoded second inlay 60 (e.g., a Mode 3 inlay) with a second unique identifier (STEP 104) at a second programming station. In some embodiments, the first and second programming stations may comprise the same programming station or be located at the same location. In some embodiments, the first and second programming stations are distinct. In STEP 106, the first unique identifier and the second unique identifier are associated with, or registered to, a given single dual standard RFID chip 50. In some embodiments, the first and second unique identifiers are associated with a common record Identifier (ID) or value associated with the given dual standard RFID chip 50. In some embodiments, the common record ID or value is an alpha numeric value assigned to the given physical given dual standard RFID chip 50 and recorded in a casino database. In some embodiments, the methodology may include assigning a common record ID to the dual standard RFID chip 50. In STEP 108, the first and second inlays 58, 60 are assembled into the carrier housing 52 with the carrier layer 56 disposed therebetween, to form the given dual standard RFID chip 50. Thereafter, the assembled given dual standard RFID chip 50 is subjected to one or more test reader processes to ensure the unique identifiers of the RFID chips 66a, 66b of the first and second inlays 58, 60 refer to, or are associated with, the common record ID of the given dual standard RFID chip 50. In some embodiments, the assembled given dual standard RFID chip 50 is subjected to a first test reader including a Mode 2 PJM reader to ensure the unique identifier of the encoded RFID chip 66a of the first inlay 58 (i.e., the Mode 2 PJM inlay) refers to, or is registered with, the common record ID of the given dual standard RFID chip 50. (STEP 110) The assembled given dual standard RFID chip 50 is then subjected to a second test reader including a Mode 3 reader to ensure the unique identifier of the encoded RFID chip 66b of the second inlay 60 (i.e., the Mode 3 inlay) refers to, or is registered with the common record ID of the given dual standard RFID chip 50. (STEP 112). Upon verification of the registering of each unique identifier of the RFID chips 66a, 66b with the common record ID of the single dual standard RFID chip 50, the chip may be distributed for use. STEPS 102-112 may be repeated for each individual dual standard RFID chip 50.

Although the process 100 is described in a particular order of STEPS 102-112, it is to be appreciated the STEPS 102-112 may be performed in any order. In some embodiments, some of the STEPS 102-212 may be simultaneously performed. It also should be noted that additional and/or different steps may be added to those depicted, not all steps depicted are necessary to any embodiment described herein and the steps may be performed in a different order in some embodiments. For example, and without limitation, the method may include assigning a common record ID to the dual stand RFID chip 50.

In another example, referring to the tracking of dual standard RFID chips 50 within a casino, one or more process modifications may be desirable to implement. For example, a centralized database to store and register multiple unique identifiers of the RFID chips 66a, 66b to a single common record ID of the single dual stand RFID chip, i.e., register the unique identifier of the Mode 2 RFID chip 66a and the Mode 3 RFID chip 66b within each given dual standard RFID chip 50 to a single common record ID of the given dual standard RFID chip 50. Additionally, various software programs and processes that use common record IDs may be desirable to update to account for a single physical dual standard RFID chip 50 now associated with multiple unique identifiers IDs of the RFID chips 66a, 66b, such that no matter the RFID standard being used to read the physical dual standard RFID chip 50, the physical dual standard RFID chip 50 can be uniquely identifiable and trackable throughout the casino. For example, a unique database structure may be implemented, such as in the non-limiting example illustrated below, which would store multiple unique identifiers for a given physical dual standard RFID chip 50 (together identifiable as related by virtue of a common record ID that a casino may store for each physical dual standard RFID chip 50 being tracked in its system). This may allow a casino system to receive a first unique RFID chip unique identifier that is read in accordance with a first RFID standard (e.g., such as at a first game event) and, based on a record in the database, correlate it to a second unique RFID chip identifier that was previously read in accordance with a second RFID standard (e.g., such as at a second game event), and process that the first RFID chip identifier and the second RFID chip identifier corresponding to the same physical common record ID of the dual standard RFID chip 50 that was involved in both gaming events.

| | First Chip | Second Chip |
|---|---|---|
| Common record ID | ID (Mode 2) | ID (Mode 3) |
| 4217809 | 8055096E | 42E624F |
| 1118763 | 8174A01F | 4134B11 |

For example, in the Table, a common record ID (e.g., common record ID No. 4217809) is assigned to a given dual standard RFID chip 50. The first RFID chip identifier (ID) 8055096E of the encoded RFID chip 66a of the first Mode 2 inlay 58 of the given dual standard RFID chip 50 is associated with, or assigned to, the common record ID of the given dual standard RFID chip 50. The second RFID chip ID 42E624F of the encoded RFID chip 66b of the second Mode 3 inlay 60 of the given dual standard RFID chip 50 is also associated with, or assigned to the same common record ID. This pairing of the first and second RFID IDs of the RFID chips 66a, 66b for the Mode 2PJM inlay 258 and the Mode 3 inlay 260 to the same common record ID is effected for each given dual standard RFID chip 50. Thus, any activity occurring within the casino with a given dual standard RFID chip 50, whether it is tracked by a Mode 2 reader or Mode 3 reader, is associated with the physical dual standard RFID chip 50.

In another example where having a single physical Casino Chip associated with multiple RFID standards and thus multiple RFID chip ID's, in a scenario where a single RFID enabled table game is equipped with both Mode 3 Readers (e.g., at player positions) and Mode 2 Readers (e.g., in chip tray), software modifications to systems for tracking physical casino chips on such a table may be desirable. For example, some RFID enabled table games may be operable to determine chip tray variance and tie it as having been caused by a specific player position (such as described in Applicant's '164 PCT Patent Publication (referenced above). In such systems (or other systems that utilize Casino Chip IDs for various purposes), such a scenario may require software program updates or modules to enable the system to translate the events read at the player position using the Mode 3 Reader and which Casino Chip(s) were read/identified, to the data being read by the Mode 2 PJM Reader in the chip tray. Such a modification may include accessing a database or table that correlates the two distinct RFID chip IDs to a Common record ID of a given casino dual standard RFID chip 50, and thus to the given chip itself.

Furthermore, a casino chip may be assigned or registered to a particular player, for example, at buy in (e.g., when the player exchanges monetary value to purchase the casino chips) or when the player wins the casino chip as a result of a wager. The particular player has a unique player identity (hereinafter “player identifier’) associated therewith which is assigned to the player by the casino. For example, a casino employee who provides the casino chips to the player registers the player identifier of the player purchasing the dual standard RFID chips 50 as being associated with each of the respective dual standard RFID chips 50 being provided to the player (e.g., the employee scans each of the chips after entering the player identifier using an RFID reader). This information is uploaded and stored on a casino database. The player identifier associated with a given casino chip may change over time as the casino chip is first provided to a first player by the casino (e.g., by a dealer at a table when the player initially buys in, or at a casino cage), and then if the casino chip is lost by the player as a result of the wager and subsequently provided to a second player as a result of a winning wager. Applicant's U.S. Pat. No. 9,694,272 to Moore et al., titled RFID-ENABLED SYSTEMS FOR FACILITATING TABLE GAMES and issued on Jul. 4, 2017 (U.S. application Ser. No. 14/994,127, filed on Jan. 12, 2016), as well as U.S. patent application Ser. No. 15/813,151 to Moore et al. and titled SYSTEMS AND METHODS FOR UTILIZING RFID TECHNOLOGY TO FACILITATE A GAMING SYSTEM, filed on Nov. 14, 2017, each describe various methodologies and supporting systems for assigning, changing and tracking a player identifier in association with a casino chip identifier. Each of these patent applications is incorporated by reference herein for all purposes and particularly for supporting and enabling systems and methods for assigning, changing and tracking which player identifier, if any, is associated with a given casino chip at any given time.

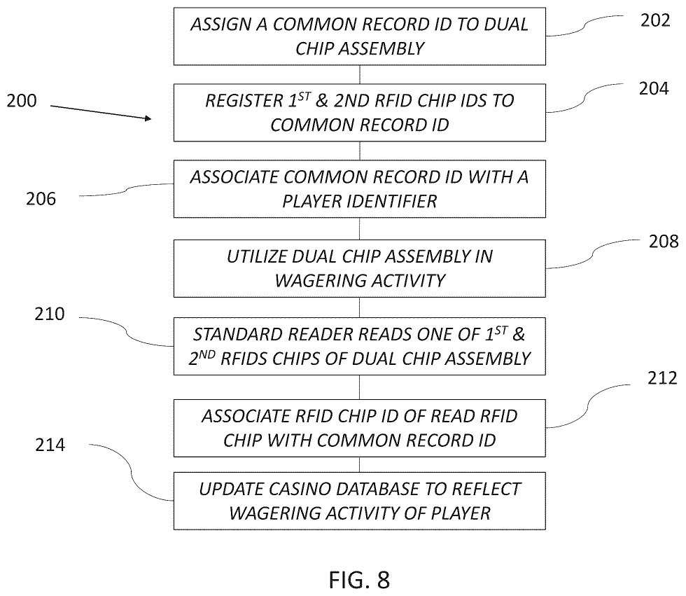

FIG. 8 illustrates a process or methodology for mapping activities associated with one or more dual standard RFID chips 50 to a particular player having a player identifier. The process 200 initially includes assigning a unique common record ID to a dual standard RFID chip 50 having first and second RFID chips 66a, 66b encoded with respective first and second RFID standards. (STEP 202) The assignment of the common record ID may occur during an initial programming stage of the process. In some embodiments, the first RFID chip 66a is encoded with a Mode 2 RFID standard and the second RFID chip 66b is encoded with a Mode 3 RFID standard. The first and second RFID chips 66a, 66b may be components of first and second inlays 58, 60 mounted to the carrier body of the dual standard RFID chip 50. In STEP 204, the respective unique identifiers (RFID IDs) of the first and second RFID chips 66a, 66b are associated with, or registered to, the common record ID of the given dual standard RFID chip 50. The RFID IDs may be assigned to the first and second RFID chips 66a, 66b during programming of the first and second inlays 58, 60.

With continued reference to FIG. 8, in STEP 206, the common record ID of the dual standard RFID chip 50 is assigned, or associated with, a unique player identifier designated for a player. The assignment or association may occur when the player purchases the one or more dual standard RFID chips 50 or when the player receives the one or more dual standard RFID chips 50 in association with winning a wager. The assignment may change over time during wagering or cash out. Applicant's U.S. Pat. No. 9,694,272 to Moore et al., titled RFID-ENABLED SYSTEMS FOR FACILITATING TABLE GAMES and issued on Jul. 4, 2017 (U.S. application Ser. No. 14/994,127, filed on Jan. 12, 2016), as well as U.S. patent application Ser. No. 15/813,151 to Moore et al. and titled SYSTEMS AND METHODS FOR UTILIZING RFID TECHNOLOGY TO FACILITATE A GAMING SYSTEM, filed on Nov. 14, 2017, each describe various methodologies and supporting systems for assigning, changing and tracking a player identifiers in association with a casino chip identifier. Each of these patent applications is incorporated by reference herein for all purposes and particularly for supporting and enabling systems and methods for assigning, changing and tracking which player identifier, if any, is associated with a given casino chip at any given time.

In STEP 208, the player utilizes at least one dual standard RFID chip 50 in a wagering activity, for example, at an electronic gaming table. The wagering activity may include, without limitation, placing the at least one dual standard RFID chip 50 in a chip tray on the electronic table to place a wager or involve loss of the dual standard RFID chip 50 in connection with a wager. In some embodiments, the electronic gaming table may include a single type of RFID standard reader available to track the wagering activity, for example, either a Mode 2PJM Reader or Mode 3 Reader. The available RFID standard reader reads one of the RFID chips 66a, 66b of the dual standard RFID chip 50 to which it is associated, or operable to read, to determine the RFID chip ID of the read RFID chip 66a, 66b (STEP 210). For example, a Mode 2P JM Reader if available at the electronic gaming table would read the data encoded in the first RFID chip 66a of the Mode 2 inlay 58 to ascertain or identify the RFID chip ID of the first RFID chip 66a. A Mode 3 Reader if available at the electronic gaming table would read the data encoded in the second RFID chip 66b of the Mode 3 inlay 60 to ascertain or identify the RFID chip ID of the second RFID chip 66b. In STEP 212, the read RFID chip ID of the read RFID chip 66a, 66b involved in the wagering activity is associated with the common record ID of the given dual standard RFID chip 50. This associates the wagering activity to the player identifier and to the player at least by virtue of the assignment of the common record ID to the unique player identifier designated for the player. In STEP 214, a casino database maintained by the gaming establishment is updated to reflect the wagering activity of the player identifier, and thus the player. For example, the wagering activity may be added to a record of the player identifier. In some embodiments, the player may be involved in additional wagering activities either at the same electronic table or in other locations. In connection with the additional wagering activities, at least STEPS 210-214 may be repeated to track, record and update a casino database representative of the wagering activities of the player through reading of the data associated with the first and second RFID chips 66a. 66b by the available RFID standard readers.

In some embodiments, a subsequent wagering activity involves the RFID chip 66,A, 66b of the dual standard RFID chip 50 previously not read by an RFID reader. In some embodiments, the electronic table may include first and second types of RFID standard readers as described hereinabove to, for example, track player and dealer positioning with a Mode 3 Reader and a chip tray with a Mode 2 PJM reader. The casino database is updated in association with each wagering activity to track or monitor the activities of the player identifier and the player.

Thus, in accordance with some embodiments, the dual standard RFID chip 50 can operate with either a Mode 2PJM Reader or Mode 3 Reader to track and document a given waging activity, occurring at the electronic gaming table, to a player identifier and to a player, and can be used throughout the casino to track all wagering activities of the player and update the database in accordance therewith.

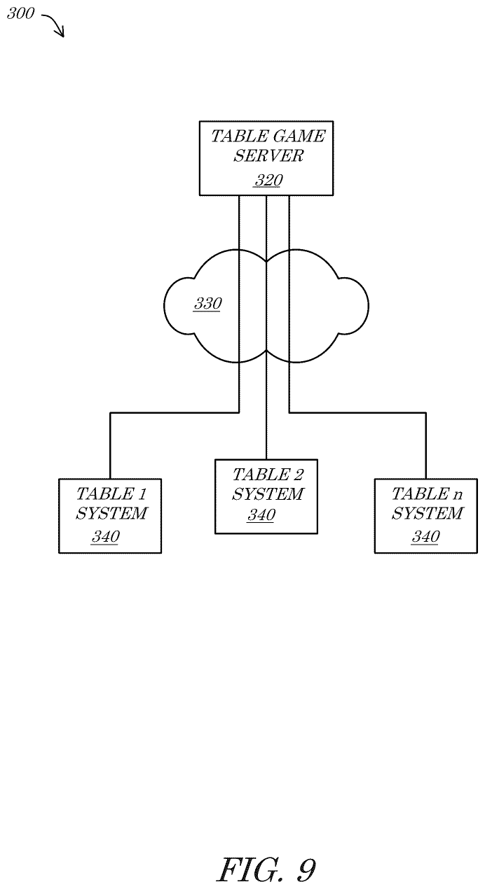

Referring now to FIG. 9, illustrated therein is a system 300 which may be useful in implementing at least some embodiments described herein. The system 300 may comprise, for example, a system within a particular gaming establishment which includes a plurality of smart tables for facilitating card games. In accordance with at least some embodiments, the system 300 includes a table game server 320 (e.g., for managing chip, player and/or game activities at one or more connected smart tables) that is in communication, via a communications network 330, with one or more table systems 340. In accordance with some embodiments, some of the table systems 340 may be equipped to read or process data using a first RFID protocol while other table systems 340 may be equipped to read or process data using a second RFID protocol. Accordingly, a casino chip comprising a dual standard RFID chip (e.g., dual standard RFID chip 50) may be utilized on any of the table systems 340.

The table game server 320 may communicate with the table systems 340 directly or indirectly, via a wired or wireless medium such as the Internet, LAN, WAN or Ethernet, Token Ring, or via any appropriate communications means or combination of communications means. Each of the table systems 340 may comprise computers, such as those based on the INTEL® PENTIUM® processor, that are adapted to communicate with the table game server 320. Any number and type of table systems 340 may be in communication with the table game server 320, although only three (3) in the example of FIG. 9.

In accordance with some embodiments, the table game server 320 may be operable to store and/or utilize a centralized database to store and register multiple unique identifiers of dual standard RFID chips to a single common record ID of the single dual stand RFID chip (e.g., register and/or track the unique identifier of the Mode 2 RFID chip 66a and the Mode 3 RFID chip 66b within each given dual standard RFID chip 50 to a single common record ID of the given dual standard RFID chip 50, as described with reference to FIG. 7). Additionally, table game server 320 may store one or more software programs or modules for performing one or more processes that use common record IDs and utilize the database and/or programs to communicate with the one or more table systems 340 in order to determine, track and/or update data corresponding to a given uniquely identified casino chip (e.g., the table game server may receive a unique identifier that was read utilizing a first RFID protocol at a first table system 340 and access a table or database such as described with respect to FIG. 7 in order to determine the unique identifier of the same casino chip in accordance with a second RFID protocol).

Communication between the table systems 340 and the table game server 320, and (in some embodiments) among the table systems 340, may be direct or indirect, such as over the Internet through a Web site maintained by table game server 320 on a remote server or over an on-line data network including commercial on-line service providers, bulletin board systems and the like. In yet other embodiments, the table systems 340 may communicate with one another and/or table game server 320 over RF, cable TV, satellite links and the like.

Some, but not all, possible communication networks that may comprise network 330 or be otherwise part of system 300 include: a local area network (LAN), a wide area network (WAN), the Internet, a telephone line, a cable line, a radio channel, an optical communications line, a satellite communications link. Possible communications protocols that may be part of system 300 include: Ethernet (or IEEE 802.3), SAP, ATP, Bluetooth and TCP/IP. Communication may be encrypted to ensure privacy and prevent fraud in any of a variety of ways well known in the art.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

In some embodiments, the table game server 320 may not be necessary and/or preferred. For example, at least some embodiments described herein may be practiced on a stand-alone table system 340 and/or a table system 340 in communication only with one or more other table systems 340 or a dedicated server device. In such an embodiment, any functions described as performed by the table game server 320 or data described as stored on the table game server 340 may instead be performed by or stored on one or more table systems 340.

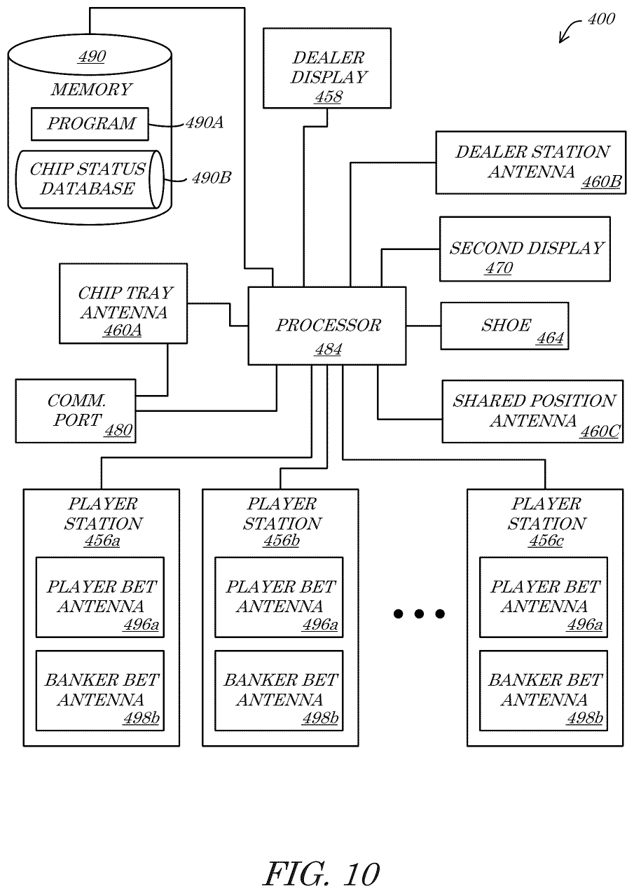

Referring now to FIG. 10, illustrated therein is a block diagram of a table system 400 consistent with some embodiments described herein. The table system 400 may comprise, for example, a table system 340 of FIG. 9. The table system 400 may be implemented as a system controller, a dedicated hardware circuit, an appropriately programmed computer which is a component or peripheral device of a table for facilitating a card game, or any other equivalent electronic, mechanical or electro-mechanical device.

The table system 400 comprises a processor 484, such as one or more INTEL® PENTIUM® processors. The processor 484 may be in communication with a memory 490 and a communications port 480 (e.g., for communicating with one or more other devices). The memory 490 may comprise an appropriate combination of magnetic, optical and/or semiconductor memory, and may include, for example, Random Access Memory (RAM), Read-Only Memory (ROM), a compact disc, tape drive, and/or a hard disk. The memory 490 may comprise or include any type of computer-readable medium. The processor 484 and the memory 490 may each be, for example: (i) located entirely within a single computer or other device; or (ii) connected to each other by a remote communication medium, such as a serial port cable, telephone line or radio frequency transceiver. In some embodiments, the table system 400 may comprise one or more devices that are connected to a remote server computer for maintaining databases.

The memory 490 may store a program 490A for controlling the processor 484. The processor 484 may perform instructions of the program 490A, and thereby operate in accordance with at least one embodiment described herein. The program 490A may be stored in a compressed, uncompiled and/or encrypted format. The program 490A may include program elements that may be necessary or desirable, such as an operating system, a database management system and “device drivers” for allowing the processor 484 to interface with computer peripheral devices (e.g., an RFID-enabled chip tray, an electronic shoe, a camera, any of which may provide data to the processor 484). Appropriate program elements are known to those skilled in the art, and need not be described in detail herein.

The term “computer-readable medium” as used herein refers to any medium that participates in providing instructions to processor 484 (or any other processor of a device described herein) for execution. Such a medium may take many forms, including but not limited to, non-volatile media, volatile media, and transmission media. Non-volatile media include, for example, optical or magnetic disks, such as memory 490. Volatile media include dynamic random access memory (DRAM), which typically constitutes the main memory. Transmission media include coaxial cables, copper wire and fiber optics, including the wires that comprise a system bus coupled to the processor 484. Transmission media can also take the form of acoustic, electromagnetic, or light waves, such as those generated during radio frequency (RF), microwave, and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Various forms of computer readable media may be involved in carrying one or more sequences of one or more instructions to processor 484 (or any other processor of a device described herein) for execution. For example, the instructions may initially be borne on a magnetic disk of a remote computer. The remote computer can load the instructions into its dynamic memory and send the instructions over a telephone line using a modem. A modem local to a table system 340 may be operable to receive the data on the telephone line and use an infrared transmitter to convert the data to an infrared signal. An infrared detector can receive the data carried in the infrared signal and place the data on a system bus for processor 484. The system bus may carry the data to a main memory, from which processor 484 may retrieve data and execute instructions. The instructions received by main memory may optionally be stored in memory 490 either before or after execution by processor 484. In addition, instructions may be received via communication port 480 as electrical, electromagnetic or optical signals representing various types of information. According to some embodiments of the present invention, the instructions of the program 490A may be read into a main memory from another computer-readable medium, such from a ROM to RAM. Execution of sequences of the instructions in program 490A may cause processor 484 to perform at least some of the functions described herein. In alternate embodiments, hard-wired circuitry may be used in place of, or in combination with, software instructions for implementation of at least one embodiment described herein. Thus, embodiments described herein are not limited to any specific combination of hardware and software.

The memory 490 may also store at least one database, such as chip status database 490B. In some embodiments, some or all of the data described herein as being stored in the database 490B may be partially or wholly stored (in addition to or in lieu of being stored in the memory 490 of the table system 400) in a memory of one or more other devices, such the table game server 340 (FIG. 9). In accordance with some embodiments, the chip status database may store chip identification data and/or chip status data (e.g., denomination, unique chip identifier, chipset identifier, gaming establishment identifier, chip value, player identifier associated with chip identifier, validity of chip, etc.). The chip status database, for example, may include the common record ID of the dual standard RFID chip 50 and the RFID chip identifiers of the RFID chips 66a, 66b for at least some or possibly all dual standard RFID chips 50 in use in the casino. In some embodiments, the memory 490 may store additional data regarding movement, location or wagering activity of, for example, with the dual standard RFID chips 50, which has occurred on the table. For example, chip movement history (e.g., an indication of which antennas or table bet positions a particular chip has been acquired at, a time at which it was acquired at a particular antenna, a time at which it was determined to no longer be at that antenna, etc.) may be stored (e.g., for determining shared bets). In some embodiments, a history of chip movements may be stored (e.g., in a file-based archive log) on another device (e.g., in a memory of table game server 340 of FIG. 9).

The processor 484 is also operable to communicate with one or more display devices: (i) a dealer display 458 and a second display 470. The second display 470 may comprise, for example, a display for displaying historical outcomes or other game information to a player. The dealer display 458 may output information such as (i) prompts for how much should be collected from players in commission or losing wagers (e.g., for each player position involved in the hand); (ii) prompts for how much should be paid out to players for winning wagers (e.g., for each player position involved in the hand); (iii) tray variance or out-of-balance alerts, informing the dealer of missing chips from the RFID-enabled chip tray; and/or (iv) other information regarding a status of the game, including information regarding a status of one or more wagers or RFID-enabled chips being used on the table. In some embodiments, one or both of the displays 458 and 470 may include or have associated therewith its own processor, memory and program (and may be operable to communicated data to and/or from the processor 484). Either of the display devices 458 and 470 may comprise, for example, one or more display screens or areas for outputting information related to game play on the gaming system, such as a cathode ray tube (CRT) monitor, liquid crystal display (LCD) screen, or light emitting diode (LED) screen. In some embodiments, either of the display devices 458 and 470 may comprise a touch screen.

As described herein, in some embodiments an RFID-enabled chip tray may comprise one or more readers or antennas for reading information from RFID-enabled chips placed in the chip tray. In such embodiments, the processor 484 is further operable to communicate with the one or more chip tray antenna(s) 460A. The one or more antenna(s) 460A may be operable to read data from one or more chips placed within a chip tray (e.g., chip identifier in accordance with a given RFID protocol, chip set identifier, chip denomination, etc.). The one or more antennas or readers may be a Mode 2 PJM reader or a Mode 3 reader operable to read Mode 2 RFID chips 66a, 66b and Mode 3 RFID chips respectively of one or more dual standard chip assemblies 50.

The processor 484 is further operable to communicate with a shared position antenna 460C, which comprises at least one antenna on a shared or common betting area for recognizing chips placed (and removed from) the shared or common betting area. In some embodiments, the processor may receive from an antenna 460 data regarding chips placed on a common betting area and determine, based on this data and additional data stored in memory (e.g., a player identifier or last player position associated with the chip that has now been acquired at the shared position antenna 460C) that a particular bet has been made by a particular player or for a particular player position. The one or more antennas or readers may be a Mode 2 PJM reader or a Mode 3 reader.

The processor 484 is further operable to communicate with a plurality of antennas at player positions placed on the table. In some embodiments each player position of a table may have a corresponding Player bet area and a Banker bet area and each such area may have associated therewith its own antenna for determining that a chip has been placed with its area. In some embodiments, the one or more antennas or readers may be a Mode 2 PJM reader and/or a Mode 3 reader. The table system 400 illustrates three player positions 456 (456a, 456b and 456c) as each having two antennas associated therewith: a player bet antenna 496a and a banker bet antenna 498b. Each such antenna may be uniquely identifiable by, for example, (i) a unique identifier associated therewith, and (ii) an identification of a port or other component of the table associated with the antenna (e.g., the port into which the antenna is plugged into may have a unique identifier associated therewith) and such unique antenna identifier may be transmitted to or recognized by the processor 484 when chip information regarding a chip acquired by a respective antenna is transmitted to the processor 484, such that the processor 484 may be programmed to determine which player position and which betting area within the player position the chip has been placed within. In some embodiments, a single player station 456 may include interrogators associated with two or more players. For example, one interrogator may be intended for a first player playing the game at the table and another interrogator for a second player (e.g., a “back bettor”) who may be betting along with or in association with the first player, either remotely or from essentially the same location, but whose chips and betting activity is to be separately tracked. In some embodiments, the chip status database 490B may store detailed data with information regarding chips identified at a table, such details being associated with a chip identifier of each chip for which data is stored (e.g., chip value, chip denomination, chipset identifier or other indicator of a category or characteristic associated with a chip), whether that chip identifier is stored in accordance with a first RFID protocol or a second RFID protocol. Storing such data at the table may allow for faster RFID scanning, since the system will not need to obtain a lot of data every time a chip is acquired or recognized by an antenna of a table (e.g., only the chip identifier may be necessary and additional information may be looked up by the system based on the chip identifier from a local database or memory). In accordance with some embodiments, the data corresponding to a given dual RFID standard casino chip may be retrieved from a database based on the unique identifier of the casino chip irrespective of whether that identifier was read using an antenna equipped to read a first RFID standard or a second RFID standard, since the database may store both unique identifiers corresponding to the respective RFID standards in association with such data.

The processor 484 is further operable to communicate with an electronic shoe 464. The shoe 464 may be an intelligent shoe such as the IS-T1™ and IS-B1™ or the MD1, MD2 sold by SHUFFLE MASTER or other such devices. The shoe 464 may be able to determine which cards are being dealt to which player station, through RFID technology, image recognition, a printed code on the card (such as a barcode), or the like. The embodiments described herein are not dependent on any particular technique used to recognize cards dealt in a card game (or cards remaining as available to be dealt). Further information about intelligent shoes may be found in U.S. Pat. Nos. 5,941,769 and 7,029,009,both of which are incorporated by reference in their entireties and U.S. Patent Application Publications 2005/0026681; 2001/7862227; 2005/0051955; 2005/0113166; 2005/0219200; 2004/0207156; and 2005/0062226 all of which are incorporated by reference in their entireties. In place of an intelligent shoe, cameras, such as may be used with pattern recognition software to detect what cards have been dealt to what player stations and what chips have been wagered at particular player stations. One method for reading data from playing cards at table games is taught by German Patent Application No. P44 39 502.7. Other methods are taught by U.S. Patent Application Publication 2007/0052167 both of which are incorporated by reference in their entirety.

The processor 484 is further operable to communicate with a dealer station antenna 460B, which comprises one or more antennas placed in a dealer area of the corresponding table. The dealer station antenna 460B may be operable to detect RFID-enabled chips which have been placed within its acquisition area, such as chips the dealer places in the area for recognizing by the system prior to placing them into the dealer tray or paying them to a player.

The processor 484 may, in some embodiments, be operable to receive the data read from the chips, for example, the dual standard RFID chips 50, by the RFID antenna 460A, derive or determine first information therefrom (e.g., total value of chips within the chip tray 460A), compare the first information to second information (e.g., an expected total value of chips which is supposed to be within the chip tray 460A based on one or more transactions or events) and output an alert or message if the first information does not match the second information or if some other condition for outputting the alert or message based on a consideration of the first information and the second information is satisfied. The alert or message may be output, for example, via dealer monitor 458. For example, the processor 484 may receive data from at least one of (i) at least one of the antennas 496a and 498b located within a player station 456a, 456b or 456c (e.g., an indication of chips placed as wagers), (ii) a shared position antenna 460C, (iii) dealer station antenna 460B, (iv) an electronic shoe 464 (e.g., cards dealt for the game).

### IV. Rules of Interpretation & General Definitions

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise. The term “herein” means “in the present disclosure, including anything which may be incorporated by reference”, unless expressly specified otherwise.

The phrase “at least one of, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise.

Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way. “Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure refers to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, Local Area Network (LAN), Wide Area Network (WAN), or Ethernet (or IEEE 802.3), Token Ring, or via any appropriate communications means or combination of communications means. Exemplary protocols include but are not limited to: BLUETOOTH™, TDMA, CDMA, GSM, EDGE, GPRS, WCDMA, AMPS, D-AMPS, IEEE 802.11 (WI-FI), IEEE 802.3, SAP, SAS™ by IGT, SUPERSAS™, OASIS™ by Aristocrat Technologies, SDS by Bally Gaming and Systems, ATP, TCP/IP, gaming device standard (GDS) published by the Gaming Standards Association of Fremont CA, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cellular networks, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The present disclosure provides, to one of ordinary skill in the art, an enabling description of several embodiments and/or inventions. Some of these embodiments and/or inventions may not be claimed in the present disclosure, but may nevertheless be claimed in one or more continuing applications that claim the benefit of priority of the present disclosure.

Although several embodiments, examples and illustrations are disclosed herein, it will be understood by those of ordinary skill in the art that the invention(s) described herein extend beyond the specifically disclosed embodiments, examples and illustrations and includes other uses of the invention(s) and obvious modifications and equivalents thereof. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the invention(s) herein described.

What is claimed is:

1. A dual standard RFID chip for use with one or more electronic table systems, which comprises:
a carrier body; and
first and second RFID chips mounted with respect to the carrier body, the first and second RFID chips encoded with a first RFID standard and a second RFID standard different from the first RFID standard.

2. The dual standard RFID chip according to claim 1, wherein the first RFID standard is a Mode 2 RFID standard and the second RFID standard is a Mode 3 RFID standard.

3. The dual standard RFID chip according to claim 1, including:
a first inlay mounted to the carrier body, the first inlay comprising the first RFID chip encoded with the first RFID standard; and
a second inlay mounted to the carrier body, the second inlay comprising the second RFID chip encoded with the second RFID standard.

4. The dual standard RFID chip according to claim 3 wherein the first RFID standard is a Mode 2 RFID standard and the second RFID standard is a Mode 3 RFID standard.

5. The dual standard RFID chip according to claim 3 including a carrier spacer disposed between the first inlay and the second inlay.

6. A method, comprising:
registering first and second RFID identifiers of first and second RFID chips to a common record ID of a single dual standard RFID chip;
wherein the method is performed by at least one processor coupled to memory.

7. The method according to claim 6 wherein the first RFID chip is encoded with a first RFID standard and the second RFID chip is encoded with a second RFID standard different from the first RFID standard.

8. The method according to claim 7 including reading with a first RFID standard reader the first RFID chip to confirm the first RFID identifier is registered to the common record ID of the single dual RFID chip.

9. The method according to claim 8 wherein first RFID chip is encoded with a Mode 2 RFID standard and wherein the first RFID standard reader is a Mode 2 standard reader.

10. The method according to claim 7 including reading with a second RFID standard reader the second RFID chip to confirm the second RFID identifier is registered to the common record ID of the single dual standard RFID chip.

11. The method according to claim 10 wherein the second RFID chip is encoded with a Mode 3 RFID standard and wherein the second RFID standard reader is a Mode 3 standard reader.

12. A method, comprising:
assigning a common record ID to a single dual standard RFID chip;
registering first and second RFID chip identifiers of respective first and second RFID chips to the common record ID;
associating the common record ID to a player identity of a player;
utilizing by the player the single dual standard RFID chip in a wagering activity at an electronic gaming table;
reading with an RFID standard reader associated with the electronic gaming table one of the first and second RFID chips;
associating the RFID chip identifier of the read one of the first and second RFID chips to the common record ID; and
updating a casino database to reflect the wagering activity of the player associated with the common record ID.

13. The method according to claim 12 wherein registering first and second RFID chip identifiers includes registering the first RFID chip identifier having a first RFID standard and registering a second RFID chip identifier having a second RFID standard different from the first RFID standard.

14. The method according to claim 13 wherein the first RFID standard is a Mode 2 RFID standard and wherein the second RFID standard is a Mode 3 RFID standard.

15. The method according to claim 14 wherein reading with an RFID standard reader includes reading one of the first and second RFID chips with one of a Mode 2 RFID standard and a Mode 3 RFID standard reader.

16. The method according to claim 15 wherein reading with an RFID standard reader includes reading the first RFID chip to obtain the first RFID chip identifier.

17. The method according to claim 15 wherein reading with an RFID standard reader includes reading the second RFID chip to obtain the second RFID chip identifier.
